(19) United States
(12) Patent Application Publication
(10) Pub. No.: US 2017/0045948 A1
(43) Pub. Date: Feb. 16, 2017

(54) CONTROLLING TARGET DEVICES

(71) Applicant: FIN ROBOTICS, INC., Mountain View, CA (US)

(72) Inventor: Rohildev Nattukallingal, Malappuram (IN)

(21) Appl. No.: 14/879,693

(22) Filed: Oct. 9, 2015

(30) Foreign Application Priority Data
Aug. 12, 2015 (IN) 4185/CHE/2015

(51) Int. Cl. G06F 3/01; G06F 3/16; G06F 3/0488; G06F 3/044

(52) U.S. Cl. CPC G06F 3/017; G06F 3/044; G06F 3/016; G06F 3/167; G06F 3/014; G06F 3/04883

(57) ABSTRACT

Methods, systems, and apparatuses for controlling a target device are disclosed. In some instances, the apparatus is a wearable apparatus in the form of a ring. The apparatus may include a gesture recognition module that recognizes a gesture made by a user, e.g., onto a capacitive track-pad. The apparatus may also include a microcontroller that correlates the gesture with a command recognizable by the target device.

### CROSS-REFERENCE TO RELATED APPLICATIONS

This application claims priority to co-pending Indian provisional patent application Serial No. 4185/CHE/2015, titled “Method, System And Wearable Apparatus For Controlling Target Device,” filed on Aug. 12, 2015, the disclosure of which is herein incorporated by reference in its entirety.

### TECHNICAL FIELD

The present description relates generally to the field of human interface control input devices, and in particular to a method, system and wearable apparatus for controlling target devices.

### BACKGROUND

With recent developments in communication technology, the use of mobile devices (e.g., smartphones, tablets, etc.) has drastically increased. For example, mobile devices can be used for making calls, for entertainment, and/or for controlling various other devices, e.g., electronic home appliances, automobiles, computing devices, etc. However, in some situations, using a mobile device to control other devices can be inconvenient. Such cases may include when a user is driving, in a meeting, working out, etc.

To address this inconvenience, certain wearable computers have been proposed to reduce user interaction with the mobile devices, thereby reducing the user's burden. Such solutions, however, have not alleviated many inconveniences associated with controlling a target device, and have created new inconveniences. For example, current wearable computer solutions may require interaction with a graphical user interface (which can be time consuming), require both hands to operate, be device specific (e.g., only control a single device or type of device), rely on limited input methods and offer minimum preconfigured operations.

Another alternative solution for controlling target devices includes the use of wireless interaction with motion sensors. For example, certain televisions include motion sensors that detect three-dimensional motions of the user. However, such electronic devices require the user to be in a particular line of sight, or movement in a particular posture, in order for the sensors to detect the motion.

Thus, what is needed is an improved technique for controlling target devices that alleviates the inconveniences associated with using a mobile device but does not create the new inconveniences of current solutions.

### SUMMARY

In general in one aspect the subject matter disclosed in this specification can be embodied in methods that include the actions of receiving a gesture to a user interface, identifying the gesture, correlating the gesture with a command recognizable by the target device, and delivering the command to the target device.

These and other aspects can optionally include one or more of the following features. The target device may include at least one of a computer, a smartphone, a smartwatch, a tablet computing device, a television, a digital media player, a set-top box, a head-mounted display, an automobile, an appliance, and an image capturing device. The received gesture may include a motion by at least a portion of a hand. The user interface may not be a graphical user interface. The user interface can include a capacitive track-pad. The identifying step may include identifying at least one of a tap, a swipe, and combinations thereof. In some cases the identifying step may further include receiving gesture data from the user interface, the gesture data including: (i) an amount of contact points made with the user interface, and (ii) a displacement for each contact point. In some such cases, the identifying step may further include forming a rectangle based on the gesture data, and comparing a property of the rectangle with a predefined value. In certain instances, the correlating step includes referencing a database that contains commands associated with gestures. In some instances, the delivering step includes delivering a wireless communication to the target device. In some instances, the delivering step includes delivering a wireless communication to a client device (e.g., a smartphone, smartwatch, and a tablet) adapted to deliver the command to the target device. The method may further include the step of receiving a notification from the target device, and in some cases, include the step of actuating a notification unit upon receiving the notification. The notification unit may produce at least of a visual, an audible, and a haptic output upon being actuated.

In general, one aspect of the subject matter disclosed in this specification can be embodied in an apparatus for controlling a target device. The apparatus can include a user interface adapted to receive a gesture from a user, a gesture recognition module in communication with the user interface and adapted to identify the gesture, a microcontroller in communication with the gesture recognition module and adapted to correlate the gesture with a command recognizable by the target device, and a communication module in communication with the microcontroller and adapted to deliver the command to the target device.

These and other aspects can optionally include one or more of the following features. The apparatus may include a finger ring. The target device may include at least one of a computer, a smartphone, a smartwatch, a tablet computing device, a television, a digital media player, a set-top box, a head-mounted display, an automobile, an appliance, and an image capturing device. In some cases, the user interface is not a graphical user interface, and in some instances, the user interface includes a capacitive track-pad. The received gesture may include a motion by at least part of a hand. The microcontroller may include a memory storing a database that contains commands associated with gestures. The communication module may be a wireless communication module, which in some cases may be adapted to receive a notification from the target device. In some instances, the apparatus further includes a notification unit in communication with the communication module and adapted to produce an output (e.g., visual, audible, or haptic) upon receipt of the notification from the target device.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various implementations of the present disclosure are described with reference to the following drawings, in which:

FIG. 1 is a block diagram of an example system including a wearable apparatus and a target device, according to an embodiment of the disclosure.

FIG. 2 is a schematic exploded view of an example wearable ring, according to an embodiment of the disclosure.

FIG. 3 is a schematic diagram illustrating a wearable ring worn on an index finger, according to an embodiment of the disclosure.

FIG. 4 shows schematic side views of an example wearable ring, according to an embodiment of the disclosure.

FIGS. 5A-7B illustrate examples of a wearable ring worn by a user to perform various functions on various target devices, according to embodiments of the disclosure.

FIG. 8 illustrates example notification patterns, according to embodiments of the disclosure.

FIGS. 9A-9B show coordinate planes that can be used to recognize gestures, according to embodiments of the disclosure.

FIG. 10 illustrates an example computing device for performing certain aspects of certain implementations of the disclosure.

### DESCRIPTION

The present description generally relates to a method, system and apparatus for controlling target devices. In some implementations, the system provides a natural user interface for controlling various target devices, as an alternative to, e.g., a graphical user interface (GUI). Although this description will primarily describe a wearable apparatus, and in particular a ring, in general the concepts described herein can be embodied in any system or apparatus configured to receive gestures and control a target device.

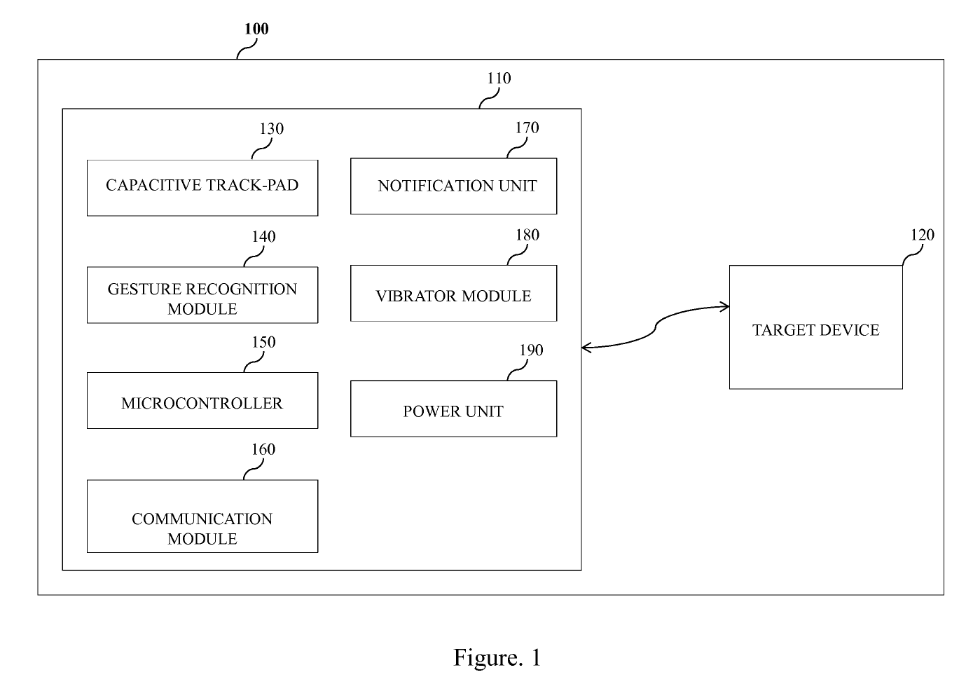

FIG. 1 is a block diagram of a system 100 including a wearable apparatus 110 and a target device 120, in accordance with one implementation. As shown, the wearable apparatus 110 may include a capacitive track-pad 130, a gesture recognition module 140, a microcontroller 150, a communication module 160, a notification unit (e.g., an LED) 170, a vibrator module 180 and a power unit 190. All are described in greater detail below.

The capacitive track-pad 130 may function as an input interface that allows a user to input spatial (gesture) data to the apparatus 110. In some instances, this type of interface can be more convenient and easier to interact with than other types of interfaces; for example, a GUI which can require a user to view a screen with heightened attention. In contrast, the capacitive track-pad 130 can be interacted with (e.g., with one hand, finger, etc.) while the user's eyes are primarily focused on something else. The capacitive track-pad 130 may include a high sensitive capacitive surface which allows the user to provide input using physical gestures, e.g., by moving a body part (e.g., hand, finger, etc.) on its surface. In some instances, the capacitive track-pad 130 provides gesture data (e.g., x, y coordinates of contact points) to the gesture recognition module 140.

The gesture recognition module 140 may be configured to receive gesture data from the capacitive track-pad 130, which can then be processed to identify the gesture made by the user. In some implementations, the gesture recognition module 140 detects swipes, taps, holds, and combination thereof. In some instances, the gesture recognition module 140 identifies the gestures as at least one of a basic gesture and a combination gesture. For example, a basic gesture may include any of: swipe right, swipe left, swipe up, swipe down, tap, hold, etc. A combination gesture may be more complicated and include multiple user actions, a few of many examples including: double tap, triple tap, tap and swipe right, tap and swipe left, tap and swipe up, tap and swipe down, swipe right and tap, swipe left and tap, swipe up and tap, swipe down and tap, double swipe right, double swipe left, double swipe up, double swipe down, etc.

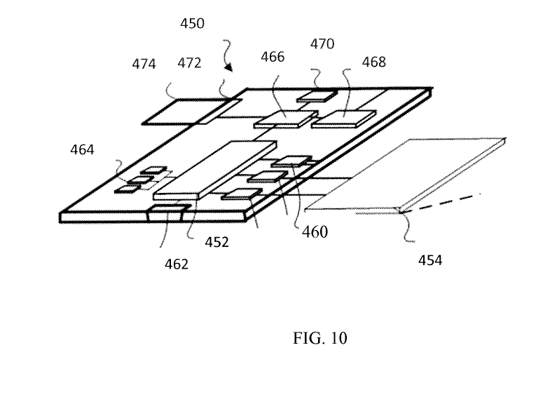

The microcontroller 150 may be a general purpose microcontroller, e.g., containing a processor, memory, and programmable input/output devices (described in more detail with reference to FIG. 10). In some implementations, the microcontroller 150 correlates the gestures identified by the gesture recognition module 140 into a command recognizable by a target device 120. Such correlation may include referencing a command associated with the received gestured in a database. Other correlation techniques are also possible. In some instances, the microcontroller 150 controls the notification unit 170 and vibrator module 180, for example, based on a communication from the target device 120. Table 1 below shows an example correlation between gestures and commands, for various devices. Table 1 is meant for illustrative purposes only, and is not exhaustive as to the listed devices, commands, or gestures.

TABLE 1

| Device Controlled | Command Delivered | Gesture Performed |
|---|---|---|
| | Accept call | swipe right |
| | Reject Call | swipe left |
| Smartphone | Volume up | swipe up |
| | Volume down | swipe down |
| Presentation Software | Next slide | swipe right |
| | Previous slide | swipe left |
| | Play pause | tap twice |
| NetFlix | Enable | swipe up twice |
| Roku | Enable | tap & swipe down |
| Roku | Disable | tap & swipe left |

The communication module 160 can generally include any components for communicating with an external device, both wired and wireless (e.g., an antenna, Bluetooth module, WiFi module, etc.). In certain implementations, the communication module 160 receives commands from the microcontroller 150 and sends the commands to the target device 120. The communication module 160 can generally communicate using known techniques, e.g., short wavelength UHF radio waves, Bluetooth, 2G, 3G, WiFi, etc. The communication module 160 can also, in some cases, receive communications as well, e.g., from the target device 120 or other devices.

In certain implementations, the notification unit 170 and/or the vibrator module 180 can provide information to the user. In some instances, under the control of the microcontroller 150, the notification unit 170 and vibrator module 180 can produce specific output patterns (e.g., combinations of audible, visual, and haptic outputs) that communicate various information to the user. The outputs can include anything capable of capturing the attention of the user, for example, blinking of LED lights, production of an audible sound, a vibration, etc. For example, the notification unit 170 can provide a visual and/or audible output, while the vibrator module 180 can provide a haptic output. In general, the communicated information can be anything of interest to a user and knowable by the apparatus 110; for example, communications from the target device 120, or information related to the operation of the apparatus 110 (e.g., battery power, etc.). For example, in an instance in which the target device 120 is a smartphone, the LED blinking twice may indicate that a message has been received by the smartphone. As another example, the vibrator module 180 vibrating twice may indicate that a pairing process with a target device is complete. As another example, the notification unit 170 producing an audible sound may indicate that the apparatus' battery is low.

The power unit 190 can generally include any technology capable of powering the apparatus, for example, a battery (e.g., alkaline battery, zinc-carbon battery, lithium battery, etc.). In some cases the power unit 190 is rechargeable (e.g., through inductive charging). In general, the target device 120 may be any device a user desires to control from apparatus 110. Some examples include: a smartphone, a smartwatch, a computer, a tablet, a head-mounted display, a smart television, a home appliance, an automobile, etc. In some implementations, the apparatus 110 can communicate directly with a target device 120. In other implementations (e.g., if the target device is not enabled with communication technology compatible with the apparatus 110), the apparatus 110 can communicate with an intermediate device capable of communicating with the target device 120 (e.g., a smartphone), and the intermediate device can deliver the command to the target device 120. The intermediate device can also be used in communications from the target device 120 to the apparatus 110 as well. In some such instances, the intermediate device can have an application installed thereon that allows it to communicate with both the apparatus 110 and the target device 120.

In some implementations, the apparatus 110 is configured to control multiple target devices 120. In such implementations, the apparatus 110 may be configured to only control one such device at a time. For example, if the apparatus 110 is configured to control a smartphone, a smartwatch, and a tablet, the apparatus 110 may only control one such device at a time. In such cases, the apparatus 110 can be informed of the device it is controlling using a manual switch located on the apparatus 110, or electronically (e.g. through a pairing process). In such cases, the same gesture can be used to control different target devices, depending on which target device the apparatus 110 is controlling at the time the gesture is received. For example, a swipe right might be a gesture that relates to both the smartphone and the smartwatch, and when a user swipes right, which device receives the command depends on which device is being controlled at that particular time. Alternatively, in such implementations, the apparatus 110 may be configured to control multiple target devices at a single time. In such cases, certain gestures can be recognized as relating to one target device 120, while other gestures can be recognized as relating to another target device 120. For example, a swipe right might be a gesture that only related to the smartphone (e.g., a command to turn it on), while a tap might be a gesture that only relates to the smartwatch (e.g., a command to turn it on). In other implementations, the apparatus 110 is configured to only control a single target device 120.

In some implementations, the user can set custom gestures that it wants to perform certain commands. In such implementations, a configuration process can be performed with the apparatus 110 in which the user informs the apparatus 110 of a gesture (e.g., by performing the gesture) that is to be associated with a particular command for a particular target device 120. The custom gestures can be stored in a memory within the apparatus 110. Taking the example, of an apparatus 110 adapted to control a smartphone, the user can initiate a configuration mode with the apparatus in which it informs it that a swipe right is a gesture for commanding the smartphone to turn on (which is a command the apparatus 110 is capable of delivering to the smartphone, either directly or indirectly). From then on, when the user performs a swipe right gesture, the apparatus 110 will deliver a “turn on” command to the smartphone. Alternatively, the user could have configured the apparatus 110 such that a tap gesture resulted in a “turn on” command being delivered. In other implementations, the apparatus 110 may be pre-configured to perform certain commands upon receipt of certain gestures.

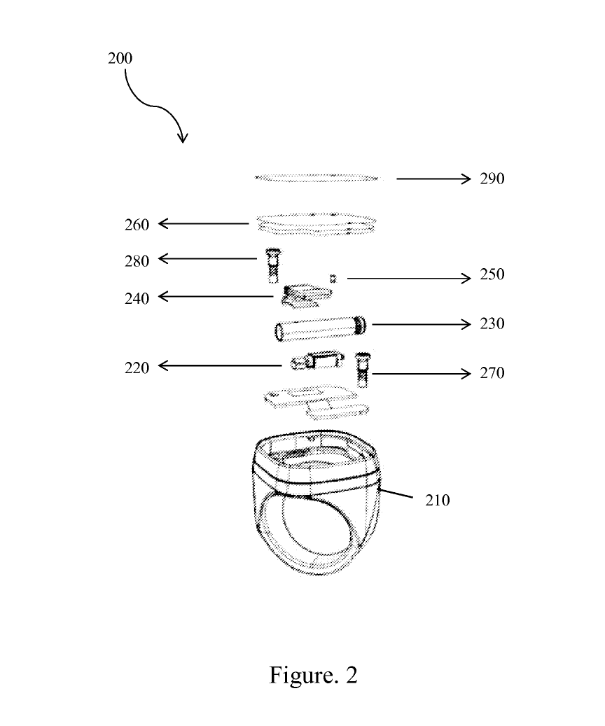

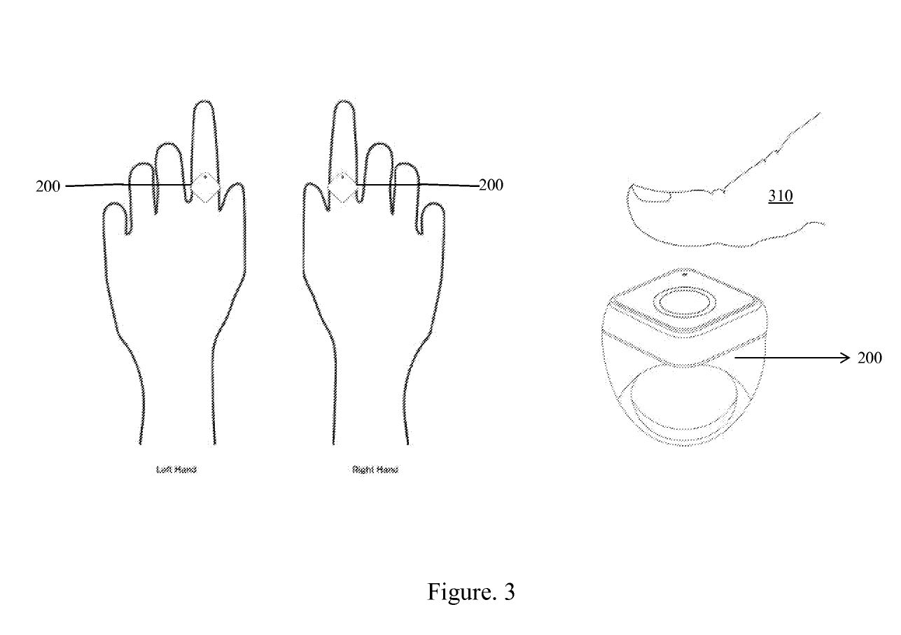

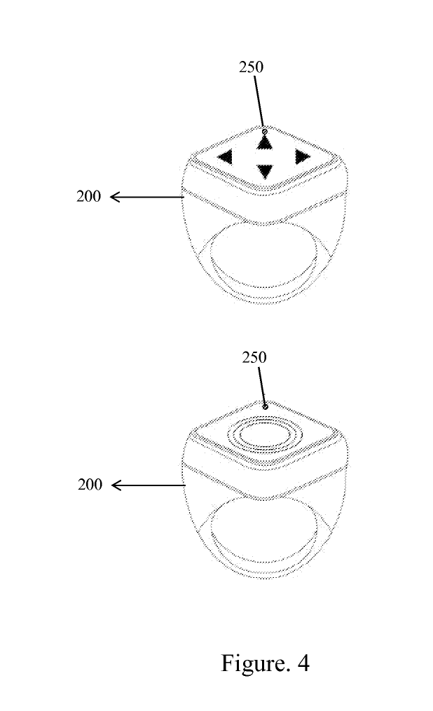

In some implementations, the apparatus 110 can include a wearable ring 200. FIG. 2 shows a schematic exploded view of an example wearable ring 200. The ring 200 may include a ring body 210 that may house one or more elements described with respect to FIG. 1. In general the ring body 210 can be made of any material, for example, metal and polycarbonate materials. In the example implementation shown, the ring 200 includes a vibrator module 220, a custom-made battery 230, a printed circuit board 240 including a microcontroller unit, an LED 250 and other circuit components, and a capacitive track-pad 260 embedded with screws 270 and 280. Further, in this example, the capacitive track-pad 260 is protected with a polycarbonate cover 290. The ring 200 may be worn on any finger of either right or left hand. In some instances, the ring is worn on a non-thumb finger and the gestures are performed by the thumb (e.g., on the capacitive track-pad 260). FIG. 3 illustrates a ring 200 worn on an index finger (as shown, on either the left or right hand) with gestures performed using the thumb 310. FIG. 4 shows schematic side views of an example ring 200. As shown, in some cases, the LED 250 may be positioned on an outer edge of the wearable ring pointing outwards from the finger.

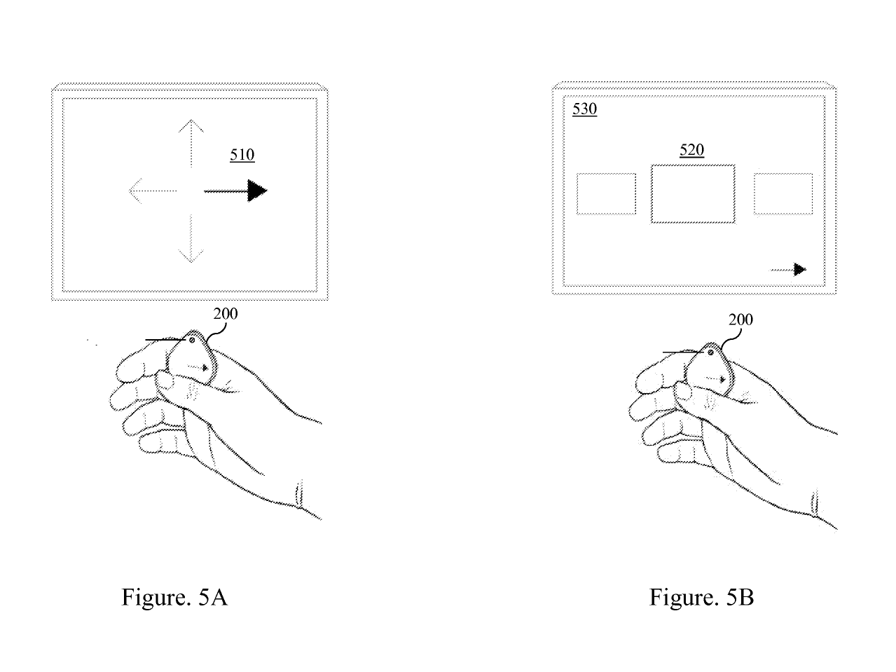

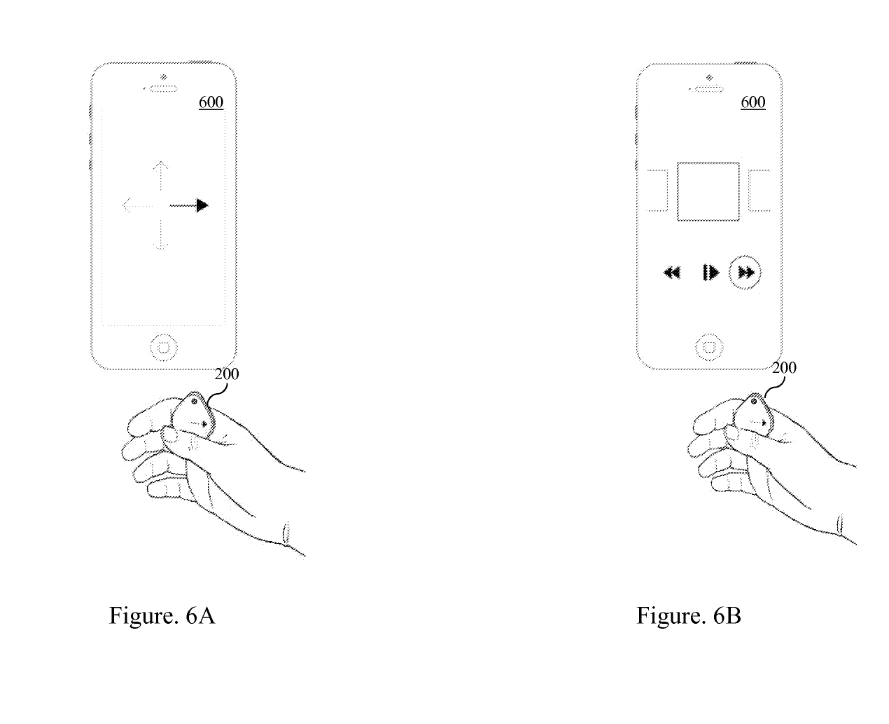

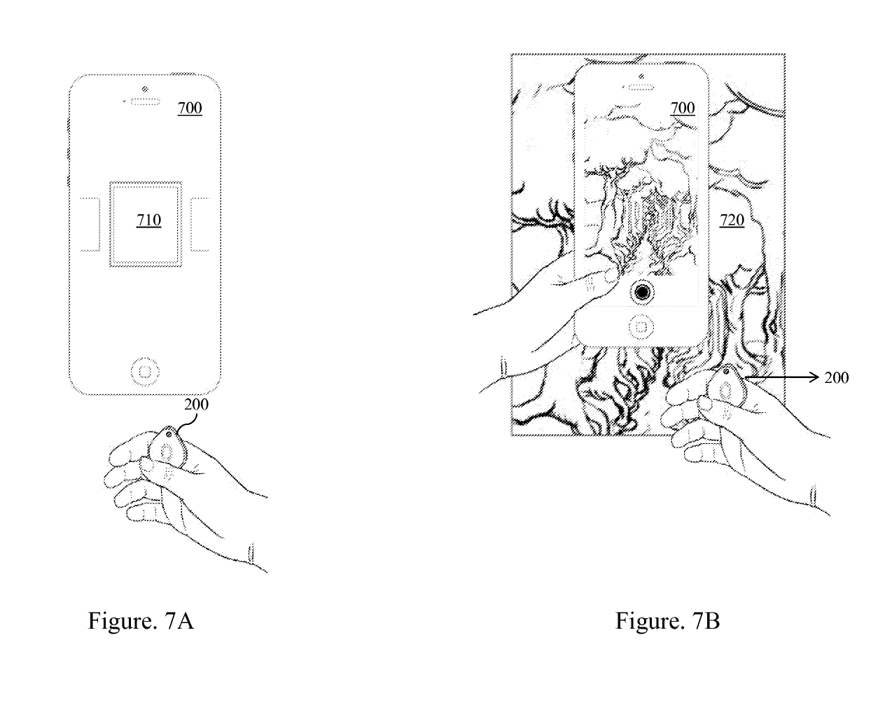

FIG. 5A-7B illustrate example uses of ring 200 to perform functions on a target device 120. These example uses are by no means exhaustive, but are merely meant to illustrate a limited number of ways in which the apparatus 110 can be used. As shown, in these examples, the ring 200 is worn on the index finger of the right hand and receives gestures from a user's thumb. FIG. 5A shows a user performing the gesture “swipe right” to scroll right on a screen 510. FIG. 5B shows a user performing the gesture “swipe right” to change a slide 520 on a screen 530. FIG. 6A shows a user performing the gesture “swipe right” to scroll right on a smartphone 600. FIG. 6B shows a user performing the gesture “swipe right” to switch a music track being played by a smartphone 600. FIG. 7A shows a user performing the gesture “tap” to select a window 710 on the screen of a smartphone 700. FIG. 7B shows a user performing the gesture “tap” to engage an image capture function on a smartphone 700 to capture an image 720.

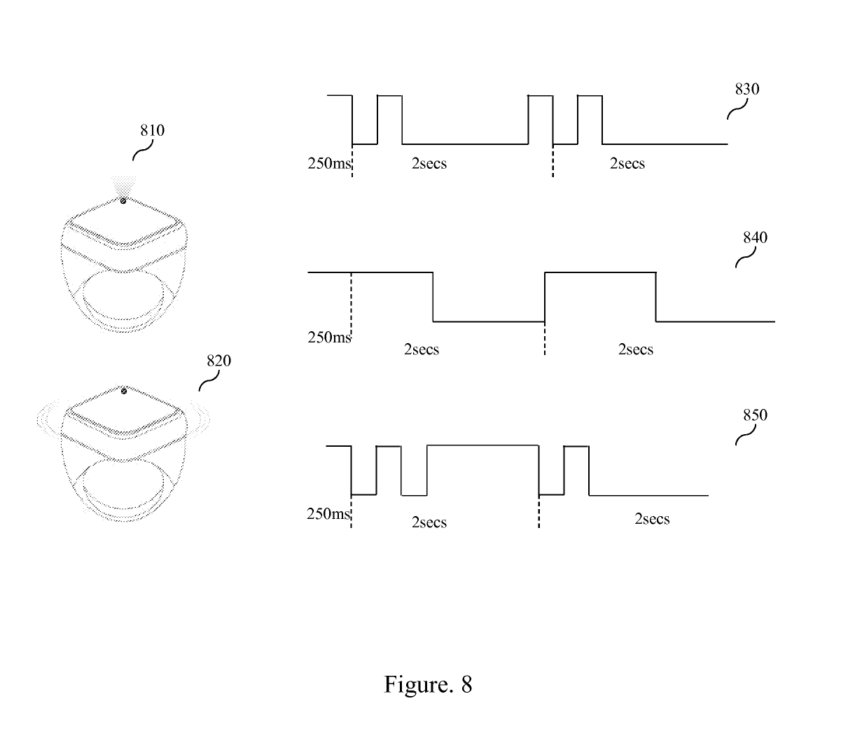

As described above, the notification unit 170 and the vibrator module 180 may perform outputs (e.g., blinking 810, vibration 820, etc.) to the user based on communications from the target device 120, or in some cases another device. For example, the notifications can occur when a user receives a call or a message. The notification types may include a buzz-type notification (e.g., an alarm notification), a rhythm-type notification (e.g., a notification every “n” minutes), a focus-type notification (e.g., a notification for every “n” minutes for “m” hours), a chirp-type notification (e.g., zero character messaging), etc. FIG. 8 illustrates example notification patterns in accordance with an embodiment of the description. For example, pattern 830 shows a quicker notification (e.g., an LED blink) occurring twice in a two second timeframe; pattern 840 shows a longer notification (e.g., a vibration) occurring once in a two second timeframe; and pattern 850 shows a combination of a quicker notification and a longer notification both occurring in a two second timeframe. Other examples (not shown) include a shorter notification repeating several (e.g., 15) times to indicate that a target device 120 is out of range notification, or a longer notification occurring several (e.g., 3) times to indicate a battery is drained.

As mentioned above, in some implementations, the gesture recognition module 140 receives gesture data (e.g., x, y coordinates) from the capacitive track-pad 130, which can be processed to identify the gesture made by the user. The manner in which one type of gesture data—x,y coordinates—is processed is described in more detail below. Similar concepts can be applied to other types of gesture data.

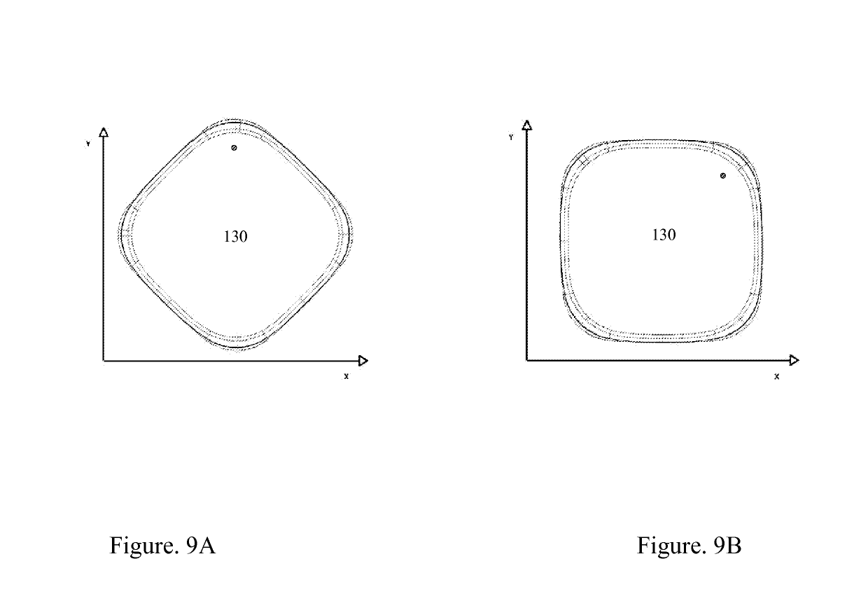

FIG. 9A show an example orientation of the x, y axes of a capacitive track-pad 130 such that gestures are performed along the diagonals of the capacitive track-pad 130. In some implementations, with reference to the x,y axes, the gesture recognition module 140 identifies a first contact point by the user, continuously tracks the position of the contact, and identifies the final contact point. FIG. 9B shows another example orientation of the x, y axes different from those shown in FIG. 9A. In some implementations, the gesture recognition module 140 can rotate the contact point data to recognize a gesture. In general, any x,y axes orientation and any shift algorithm can be used. Taking the example shown in FIG. 9B, the gesture recognition module can employ the following shift calculation to determine the contact point data: Shifted x=(x+y)*sin (45); Shifted y=(x−y)*sin (45).

From the received gesture data (shifted or not), in some instances, the gesture recognition module 140 extracts certain information, for example: number of contact points, displacement from first point to last point, width (e.g., maximum x−minimum x), height (e.g., maximum y−minimum y) and various ratios (e.g., width/height and height/width). In certain implementations, the gesture recognition module 140 forms a rectangle which includes the received gesture data. The rectangle can be formed, e.g., using the extracted width and height. In some such cases, the gesture recognition module 140 may recognize the gesture based on the properties of the rectangle. As one example, the gesture recognition module 140 may first check for a tap by comparing the rectangle with a pre-defined “Tap Width Threshold” and/or “Tap Height Threshold.” If the rectangle width is less than the “Tap Width Threshold” or the rectangle height is less than “Tap Height Threshold,” then the gesture is recognized as a tap. Another example way in which the gesture recognition module 140 may recognize a gesture as a tap is if there is only one detected contact point.

The gesture recognition module 140 may also check for swipes. In some instances, the gesture recognition module 140 may recognize a horizontal (right or left) or vertical (up or down) swipe by comparing an identified ratio (e.g., width/height and height/width, as described above) with pre-defined aspect ratios. For example, if the identified ratio is greater than a pre-defined aspect ratio, then the gesture recognition module 140 identifies the gesture as a horizontal swipe. As another example, if the identified height/width ratio is greater than a pre-defined aspect ratio, then the gesture recognition module identifies the gesture as a vertical swipe. In some instances, once a swipe is identified, the gesture recognition module 140 determines the displacement of the swipe. For example, if the displacement is positive, then the gesture recognition module 140 may identify the swipe as either an up swipe (for a vertical swipe) or a right swipe (for a horizontal swipe); if the displacement is negative, then the gesture recognition module 140 may identify the swipe as either a down swipe (for a vertical swipe) or left swipe (for a horizontal swipe). The above description is merely one technique the gesture recognition module 140 can use to identify gestures; other techniques are possible.

In certain implementations, the gesture recognition module 140 may identify gestures (e.g., gestures with combinations of taps and swipes) using a gesture timer and a gesture counter.

For example, after a first gesture (e.g., a swipe or a tap) is detected, the gesture recognition module 140 may set a gesture counter to “1,” and activate a gesture timer to run up to “n” milliseconds (e.g., 200 ms). If an additional gesture is detected during the “n” millisecond period, the module 140 can increase the gesture counter by 1 (e.g., to “2”) and reset the gesture timer. This process may continue until no additional gesture is detected during an “n” millisecond period, at which time the gestures detected at the expiration of that period are considered the final gesture. As one example, if two basic gestures—a tap, and a right swipe—are detected before an “n” millisecond period in which no gesture is detected, then the final gesture is “tap and swipe right.” In some cases, after detecting the final gesture, the gesture recognition module 140 may reset the gesture counter.

### Operating Apparatus

FIG. 10 shows an example of a computing device 450 (e.g., microcontroller 150), which may be used with some of the techniques described in this disclosure. Computing device 450 includes a processor 452, memory 464, an input/output device 454 (e.g., capacitive track pad 130), a communication interface 466 (e.g., communication module 160), and a transceiver 468, among other components. The device 450 may also be provided with a storage device, such as a microdrive or other device, to provide additional storage. Each of the components 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. The processor may provide, for example, for coordination of the other components of the device 450, such as control of user interfaces, applications run by device 450, and wireless communication by device 450.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provided as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, memory on processor 452, or a propagated signal that may be received, for example, over transceiver 468 or external interface 462.

Device 450 may communicate wirelessly through communication interface 466 (e.g., communication module 160), which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning System) receiver module 470 may provide additional navigation- and location-related wireless data to device 450, which may be used as appropriate by applications running on device 450.

Device 450 may also communicate audibly using audio codec 460 (e.g., part of notification unit 170 or communication module 160), which may receive spoken information from a user and convert it to usable digital information. Audio codec 460 may likewise generate audible sound for a user, such as through a speaker. Such sound may include sound from voice telephone calls, may include recorded sound (e.g., voice messages, music files, etc.) and may also include sound generated by applications operating on device 450.

### Operating Environment

Some implementations of the subject matter and the operations described in this disclosure can be implemented in digital electronic circuitry, or in computer software, firmware, or hardware, including the structures disclosed herein and their structural equivalents, or in combinations of one or more of them. Some implementations of the subject matter described in this disclosure can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this disclosure can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., apparatus 110, or an intermediate device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Implementations of the subject matter described in this specification can be implemented in a computing system that includes a back-end component, e.g., as a data server, or that includes a middleware component, e.g., an application server, or that includes a front-end component, e.g., apparatus 110, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some implementations, a server transmits data to a user device (e.g., apparatus 110). Data generated at the user device (e.g., a result of the user interaction) can be received from the user device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes described do not necessarily require the particular order described, or sequential order, to achieve desirable results. In certain implementations, multitasking and parallel processing may be advantageous.

What is claimed is:

1. A method for controlling a target device, the method comprising the steps of:
receiving a gesture to a user interface;
identifying the gesture;
correlating the gesture with a command recognizable by the target device; and
delivering the command to the target device.

2. The method of claim 1, wherein the target device comprises at least one of a computer, a smartphone, a smartwatch, a tablet computing device, a television, a digital media player, a set-top box, a head-mounted display, an automobile, an appliance, and an image capturing device.

3. The method of claim 1, wherein the received gesture comprises a motion by at least a portion of a hand.

4. The method of claim 1, wherein the user interface is not a graphical user interface.

5. The method of claim 4, wherein the user interface comprises a capacitive track-pad.

6. The method of claim 1, wherein the identifying step comprises identifying at least one of a tap, a swipe, and combinations thereof.

7. The method of claim 6, wherein the identifying step further comprises receiving gesture data from the user interface, the gesture data comprising: (i) an amount of contact points made with the user interface, and (ii) a displacement for each contact point.

8. The method of claim 7, wherein the identifying step further comprises:
forming a rectangle based on the gesture data; and
comparing a property of the rectangle with a predefined value.

9. The method of claim 1, wherein the correlating step comprises referencing a database that comprises commands associated with gestures.

10. The method of claim 1, wherein the delivering step comprises delivering a wireless communication to the target device.

11. The method of claim 1, wherein the delivering step comprises delivering a wireless communication to a client device adapted to deliver the command to the target device.

12. The method of claim 11, wherein the client device comprises at least one of a smartphone, a smartwatch, and a tablet computing device.

13. The method of claim 1, further comprising receiving a notification from the target device.

14. The method of claim 13, further comprising actuating a notification unit upon receiving the notification.

15. The method of claim 14, wherein the notification unit produces at least one of a visual, an audible, and a haptic output upon being actuated.

16. An apparatus for controlling a target device, the apparatus comprising:
a user interface adapted to receive a gesture from a user;
a gesture recognition module in communication with the user interface and adapted to identify the gesture;
a microcontroller in communication with the gesture recognition module and adapted to correlate the gesture with a command recognizable by the target device; and
a communication module in communication with the microcontroller and adapted to deliver the command to the target device.

17. The apparatus of claim 16, wherein the apparatus comprises a finger ring.

18. The apparatus of claim 16, wherein the target device comprises at least one of a computer, a smartphone, a smartwatch, a tablet computing device, a television, a digital media player, a set-top box, a head-mounted display, an automobile, an appliance, and an image capturing device.

19. The apparatus of claim 16, wherein the user interface is not a graphical user interface.

20. The apparatus of claim 19, wherein the user interface comprises a capacitive track-pad.

21. The apparatus of claim 16, wherein the received gesture comprises a motion by at least part of a hand.

22. The apparatus of claim 16, wherein the microcontroller comprises a memory storing a database comprising commands associated with gestures.

23. The apparatus of claim 16, wherein the communication module is a wireless communication module.

24. The apparatus of claim 16, wherein the communication module is further adapted to receive a notification from the target device.

25. The apparatus of claim 24, further comprising a notification unit in communication with the communication module and adapted to produce an output upon receipt of the notification from the target device.

26. The apparatus of claim 25, wherein the notification unit produces at least one of a visual, an audible, and a haptic output.
